(19) United States
(12) Patent Application Publication
(10) Pub. No.: US 2004/0209035 A1
(43) Pub. Date: Oct. 21, 2004

(54) Colored digital versatile disc

(76) Inventor: Ming-Te Lai, Luzhu Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/842,570

(22) Filed: May 11, 2004

(30) Foreign Application Priority Data
Feb. 10, 2003 (TW) 093201880

(51) Int. Cl. B32B 3/02

(52) U.S. Cl. 428/64.4

(57) ABSTRACT

A colored digital versatile disc (colored video disc) comprises an upper layer and a lower layer. The lower layer is the combination of a reflective layer, a recording layer, and a substrate and the upper layer is made of the resin and some paints with special effects such as temperature-sensitive dye, hidden dye, metallic dye, aromatic dye, and metal oxide or mica dye. These special pigments and resin are configured via the injection molding so as to shorten the manufacturing procedure.

### BACKGROUND OF THE INVENTION

1. Field of the Invention

The present invention relates to an optical information recording medium especially the structure of digital video disc (DVD) the adhering of a colored upper layer (Dummy) and a lower layer.

2. Description of the Related Art

Upon the invention of colored discs, various kinds of plastic coloring methods such as base coloring, PC coloring, and liquid dye coloring have been widely applied in the producing of colored discs. However, all the existing producing methods of colored disc are adopting the transparent dye capable of radiation transmission to absorb the wavelength and all have the substrate or data storage sheet colored as well. The present colored discs, including CD, CD-R, CD-RW, DVD, DVD-R, DVD-RW, and DVD-RAM, are employing the technology of coloring the data storage substrate, and inevitably, all the colored discs must be conducted with the procedure of printing so as to label the contents of products or segment the brands and product styles. According to the Taiwan Patent NO.452790 about the colored discs and its manufacturing method in Taiwan, wherein, the substrate is a light-transmissive colored layer.

More clearly, the general manufacturing method of DVD is shown in FIG. 1, which is the conventional technology illustrating the structure of digital versatile disc. The structure of the conventional disc in FIG. 1 includes an upper layer 10 and a lower layer 20, and the lower layer 20 is the combination of a substrate 22, a recording layer 24, and a reflective layer 26.

Supporting the disc and being capable of radiation-transmissive, the substrate 22 at the rear of the disc (luminary surface) is the chassis of the disc with the thickness of nearly 1.2 mm (0.12 cm), made of the polycarbonate material. And with the thickness of mere angstrom, the recording layer 24 on which the data is stored, is generally formed with the aluminum, the gold, or the copper alloy, to reflect the laser signal. Further to the upper layer 10, laminated as the underneath of printing, its purpose is to protect the reflective layer 26 from being oxidized to deterioration. At last, upon the coating of resin 12 on the upper layer 10, the patterns are printed on the disc via the silk-screen printing or lithography.

Therefore, it's time consuming and very costly in ink that all the conventional practices employ the coating of resin 12 on the surface of the upper layer 10 of digital versatile disc (DVD) and then with the letters or the patterns printed thereon upon finishing the producing of the digital versatile disc.

This being the case, to conquer the above-mentioned problem, the invention of the colored digital disc not only can improve the failure of the conventional practice in coating a layer of resin on the upper layer in extra, but also is always the expectation of all the users and the concern of this invention. Because of the long engagement in the research, invention, and sales experience about the related products of storing and recording mediums, the improvement idea has been developing gradually. Applying the personal professional knowledge, at last, the solution of colored digital versatile disc to the above-mentioned problem has been figured out through a lot of study designs and seminars.

### SUMMARY OF THE INVENTION

It is an object of the present invention to provide a colored digital versatile disc by using a colored upper layer, which includes the resin such as PC, PMMA, PS, PE, and PP and the pigment with special effect. The colored layer is configured via injection molding and then bonded together with lower layer without another layer of lacquer printed in the procedure so as to shorten the lead time of producing and cut down the cost of ink material.

Not only to shorten the producing procedure and cut down the producing cost, it's the second purpose of the present invention to enhance the quality of the products and to promote a variety of the products via the color of the upper layer as well, thus securing the competitiveness. In conclusion, to attain the aforementioned purposes and advantages, the present invention is to offer a colored digital versatile disc, the bonding of an upper layer and a lower layer. The lower layer is the combination of a reflective layer, a recording layer, and a substrate and the upper layer is made of the resin and some paints with special effect via the injection molding so as to shorten the manufacturing procedure.

### BRIEF DESCRIPTION OF THE DRAWINGS

FIG. 1 is a perspective view of the structure of the digital versatile disc in the conventional technology.

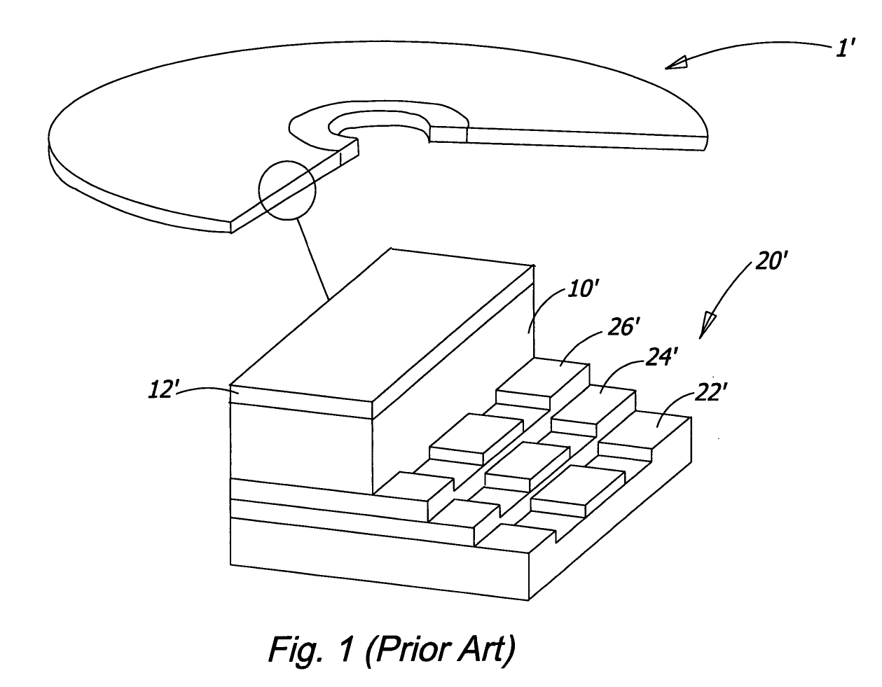

FIG. 2 is a cross-section showing a preferred embodiment of the structure of the colored digital versatile disc in the present invention.

### DETAILED DESCRIPTION OF THE PREFERRED EMBODIMENT

To have a further understanding about the features of the structure and the achieved effects, of the present invention, the preferred embodiment and the detailed description are unfolded as following.

The present invention is taking advantage of the structure of a colored upper layer to substitute the necessary procedure of printing a layer of lacquer on the upper layer in the conventional technology so as to shorten the printing procedure substantially, cut down the cost of ink, and moreover, to enhance the quality of the disc surface and, to form a variety of color combinations by collocating the colors of the upper and the lower layers.

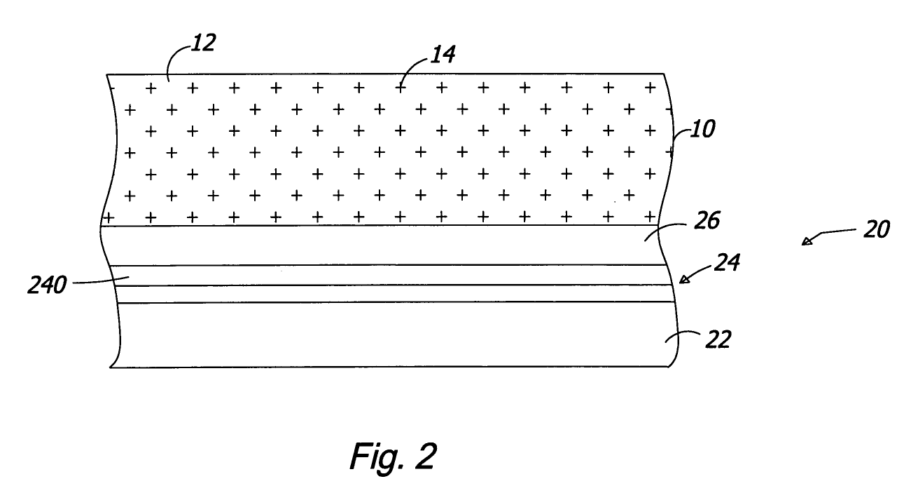

First of all, the FIG. 2 demonstrates the cross-section view of the preferred embodiment about the colored digital versatile disc. The invented main structure of the colored digital versatile disc includes an upper layer 10 and a lower layer 20. Bonding the upper layer 10, which is already a colored layer, and the lower layer 20 together directly, there is no necessary to print a layer of lacquer in advance of printing the product description and the like as the conventional DVD doing.

In the invented structure, the upper layer (Dummy) is made of the resin and some paints with special effects such as temperature-sensitive dye, hidden dye, metallic dye, aromatic dye, metal oxide or mica dye and the collocations of any of the special dye. And the material of resin 12 is selected from PC, PMMA, PS, PE, PP, and etc. Then, via the injection molding, the 6 mm blank disc without the groove signal is configured to primarily maintain enough thickness and disc strength without the function of recording. Furthermore, compared to the upper layer 10, the lower layer 20 is pre-carved with groove signals on the injected stamper, and then being transferred the groove signals to the substrate, made of PC, PMMA, or the like, via the disc injection molding technology. And then, the optical substrate with grooves can either be configured as a pre-recording disc when it is directly sputtered with the reflective layer 26, or be formed as a digital versatile disc when it is coated with a recording dye (i.e., the producing procedure of DVD) or sputtered with a magnetic metal recording layer (that is, the producing procedure of DVDRW), and at last, bonded with the upper layer 10 before the sputtered reflective layer 26. Therein, the lower layer 20 includes a substrate 22, a recording layer 24, and a reflective layer 26. The recording layer 24 is with substrate thereon and a reflective layer there-under.

Amidst the structure, there is an organic dye layer 240 wholly covering on the reflective layer 26 (i.e., a totally flat aluminum sheet). And the difference of pigment materials would contribute to various colors such as golden chip, blue chip, green chip, and etc.

The present invention relates to a colored upper layer so as to get rid of the originally necessary layer of lacquer-on which the patterns or the letters are then printed to demonstrate the production specification, the data format, or the name of the storage information in the disc-printed on the upper layer in the conventional practice. In addition, the present invention utilizes the pigment with kind of special effect combined with the resin via the injection molding to configure a colored upper layer, which then boned together with a lower layer, the combination of a substrate, a recording layer, and a reflective layer. Because of the colors of the colored recording layer such as gold (golden chip), green (green chip), blue (blue chip), and so on, it facilitates the shortened producing procedure, the cut-down cost, and more, the enhanced quality and the increased variety of products.

In conclusion, the present invention definitely achieves creativity, improvement, and more, usability for the users in the industry. This being the case, it should be qualified for the patent applications in the intellectual patent regulation of our country, thus, being proposed for the approval of the patent. Looking forward to the kind rendering of the approval at the earliest convenience.

The above-mentioned practice is only a preferred embodiment of the present invention, not the specified limit of it. All the parallel changes and revisions of the shape, the structure, the feature, and the spirit evolving from the present invention should be included in the field of the claimed patent of the present invention.

What is claimed is:

1. A colored digital versatile disc structure comprising:
an upper layer (Dummy) comprising a resin and a pigment with special effect; and
a lower layer there-under said upper layer, comprising:
a substrate,
a recording layer with said substrate there-under, and
a reflective layer with said recording layer there-under;
wherein said upper layer and said lower layer are bonded together into said colored digital versatile disc.

2. The colored digital versatile disc as claimed in claim 1, wherein said resin of said upper layer is selected from a group of PC, PMMA, PS, PE, PP, and other transparent plastic materials.

3. The colored digital versatile disc as claimed in claim 1, wherein said pigment with special effect of said upper layer includes a temperature-sensitive dye.

4. The colored digital versatile disc as claimed in claim 1, wherein said pigment with special effect of said upper layer includes a hidden dye.

5. The colored digital versatile disc as claimed in claim 1, wherein said pigment with special effect of said upper layer includes a metallic dye.

6. The colored digital versatile disc as claimed in claim 1, wherein said pigment with special effect of said upper layer includes an aromatic dye.

7. The colored digital versatile disc as claimed in claim 1, wherein said pigment with special effect of said upper layer includes a metal oxide or mica dye.

8. The colored digital versatile disc as claimed in claim 1, wherein the storing and recording medium can be used in storing data, image, audio, or video.
